(19) United States
(12) Patent Application Publication
(10) Pub. No.: US 2006/0086546 A1
(43) Pub. Date: Apr. 27, 2006

(54) Internal combustion engines for hybrid power train

(75) Inventors: Haoran Hu, Novi, MI (US); David Merrion, Brighton, MI (US)

Correspondence Address: HARNESS, DICKEY & PIERCE, P.L.C., P.O. BOX 828, BLOOMFIELD HILLS, MI, 48303, US

(73) Assignee: Green Vision Technology, LLC

(21) Appl. No.: 11/299,332

(22) Filed: Dec. 9, 2005

Related U.S. Application Data
(63) Continuation-in-part of application No. 10/360,944, filed on Feb. 7, 2003.
(60) Provisional application No. 60/355,546, filed on Feb. 8, 2002.

(51) Int. Cl. B60K 6/00

(52) U.S. Cl. 180/65.2

(57) ABSTRACT

A hybrid power train and method for operating same in which the operation of the engine is modified to effect an improvement in the fuel economy and/or emissions performance of the hybrid power train. In one embodiment, the battery of the power train is employed to provide auxiliary heat to an engine aftertreatment system to thereby improve the effectiveness of the aftertreatment system. In another embodiment, various components of the engine, such as a water pump, are wholly or partly operated by electric motors that receive power from the battery of the power train. In another embodiment, engine braking can be employed in situations where regenerative braking does not provide sufficient braking torque. In a further embodiment, the engine valves may be selectively opened to reduce pumping losses associated with the back-driving of the engine.

### CROSS-REFERENCE TO RELATED APPLICATIONS

This application is a continuation-in-part of U.S. patent application Ser. No. 10/360,944 filed Feb. 7, 2003, which claims the benefit of U.S. Provisional Application No. 60/355,546, filed on Feb. 8, 2002.

### INTRODUCTION

The invention relates to hybrid power trains and more specifically to a method for improving fuel economy and/or reducing exhaust emissions in internal combustion engines for use in hybrid power trains.

The recent development of hybrid power trains in the automotive industry has demonstrated encouraging results for reductions in fuel consumption and exhaust emissions. A vehicle with a hybrid power train usually includes an internal combustion engine, an electric generator, an electric motor, a battery and other equipment. In series hybrid vehicles, the generator is driven by the mechanical output of the internal combustion engine. The output of the generator is then combined with the output of the battery to drive the electric motor, such that the mechanical output of the motor drives the vehicle. In contrast, the parallel hybrid vehicle includes an internal combustion engine, a regenerative brake/motor and an electric energy storage device such as a battery and other equipment. PHVs are usually driven directly by the mechanical output of the internal combustion engine. However, when the vehicle must be accelerated or decelerated at a rate that cannot be accomplished by the internal combustion engine alone, or if the drive efficiency of the engine would be degraded if only the internal combustion engine were used, the regenerative brake/motor, which is mechanically connected to the internal combustion engine, operates as an electric motor (on acceleration) or as a regenerative brake (on deceleration) to meet the required rate of acceleration or deceleration through the combined output of the internal combustion engine and the regenerative brake/motor.

The internal combustion engine of a hybrid power train has narrow operating range. In series hybrid vehicles, the internal combustion engine is not directly connected to the driving wheels while in parallel hybrid vehicles, the regenerative brake/motor provides rapid acceleration or deceleration. Therefore, the internal combustion engine used in hybrid power trains can be optimized for better fuel economy and less exhaust emissions relative to power trains that are solely powered by conventional internal combustion engines.

Examples of hybrid vehicles and their operating modes have been described in detail in several patents. For example, in U.S. Pat. No. 5,656,921, a parallel hybrid vehicle is disclosed having power sources from a SI (spark ignition) engine and an electric motor. It employs fuzzy logic rules to adjust the entries in the tables determining the power splitting between the SI engine and the electric motor. The performance measure used to adjust the entries is given by the weighted ratio between the battery current and fuel flow rate. In U.S. Pat. No. 5,943,918, granted to Reed and U.S. Pat. No. 6,164,400 granted to Jankovic, a hybrid power train is described which uses power delivered by both the internal combustion engine and the electric motor. A shifting schedule was developed for a multiple ratio transmission to establishing a proportional relationship between accelerator pedal movement and the torque desired at the wheel. U.S. Pat. No. 6,223,106 granted to Toru Yano et al. and U.S. Pat. No. 6,318,487 granted to Yanase et al. each describe a hybrid vehicle control system operable to prevent the battery from being overcharged during regenerating braking. U.S. Pat. No. 5,725,064, describes a control system operable to open the intake and exhaust valves to reduce the pumping loss when the vehicle is operating in reverse or its electric motor driving mode without using a clutch device to disconnect the internal combustion engine from the transmission. Finally, U.S. Pat. No. 6,266,956 describes an exhaust emission control system for a hybrid car using a separate combustion device to heat the catalyst and to provide hydrocarbons as the reducing agent to the lean NOx catalyst.

The primary focus of the above patents is the drivability of the hybrid vehicle. Unfortunately, little efforts have been applied to the development and integration of the internal combustion engines to optimize the benefits of the hybrid power train for lower cost, better fuel economy and lower exhaust emissions, especially, for the heavy-duty diesel engines for the urban and on-highway truck and bus applications.

### SUMMARY

In one form, the present teachings provide a method that includes: providing a hybrid power train having a transmission that is selectively powered by a diesel engine, a motor/generator, or both, the diesel engine having a turbocharger, the motor/generator being coupled to a battery which supplies electric power to the motor/generator; operating the diesel engine; identifying an event where increased responsiveness of the turbocharger is desired; and operating an. electric motor to drive a compressor in the turbocharger.

In another form, the present teachings provide a method that includes: providing a hybrid power train having a diesel engine and an electric motor, the diesel engine including a NOx reduction catalyst, a plurality of cylinders, and a fuel injector, a plurality of exhaust valves, a plurality of intake valves, and a piston being associated with each cylinder; operating the hybrid power train in a first mode wherein propulsive power is supplied at least partially by the electric motor; operating the hybrid power train in a second mode wherein propulsive power is supplied solely by the diesel engine; and operating at least one of the fuel injectors to perform post-ignition fuel injection wherein fuel is dispensed into an associated one of the cylinders after initiation of a combustion event in the associated one of the cylinders and prior to completion of an exhaust stroke of an associated one of the pistons.

In yet another form, the present disclosure provides a method that includes: providing a hybrid power train having a diesel engine and a motor/generator, the diesel engine including a NOx reduction catalyst, a diesel particulate filter, a plurality of cylinders, and a fuel injector, a piston, a plurality of intake valves and a plurality of exhaust valves being associated with each of the cylinders; operating the hybrid power train in a first mode wherein propulsive power is supplied at least partially by the motor/generator; operating the hybrid power train in a second mode wherein propulsive power is supplied solely by the diesel engine; and performing a maintenance routine when the diesel engine is operating wherein post-injection fuel is provided to at least one of the cylinders to provide a source of hydrocarbons and valve timing is adjusted to open the exhaust valves of one or more of the cylinders earlier to elevate a temperature of an exhaust of the diesel engine, the maintenance routine being operable to regenerate one or both of the NOx reduction catalyst and the diesel particulate filter.

In still another form, the present teachings provide a method for operating a hybrid power train having a transmission, a diesel engine, a motor/regenerative brake, a battery, and an electronic controller, the transmission being selectively powered by at least one of the diesel engine and the motor/regenerative brake, the battery being coupled to the motor/regenerative brake, the electronic controller being coupled to the diesel engine, the motor/regenerative brake and the battery, the diesel engine including a plurality of cylinders, each of the cylinders having one or more intake valves and one or more exhaust valves. The method includes: operating the hybrid power train in a mode wherein the diesel engine is not providing rotary power to the transmission; operating the motor/regenerative brake in a mode that absorbs power to thereby decelerate the hybrid power train and back drive the diesel engine; and adjusting the valve opening of at least one of the exhaust valves and the intake valves during operation of the motor/regenerative brake in the power absorbing mode.

In still another form, the present teachings provide a method for operating a hybrid power train having a transmission, a diesel engine, a motor/regenerative brake, a battery, and an electronic controller, the transmission being selectively powered by at least one of the diesel engine and the motor/regenerative brake, the battery being coupled to the motor/regenerative brake, the electronic controller being coupled to the diesel engine, the motor/regenerative brake and the battery, the diesel engine including a plurality of cylinders, each of the cylinders having one or more intake valves and one or more exhaust valves. The method includes: identifying a deceleration event in which the hybrid power train is to be decelerated; and operating the motor/regenerative brake in a mode that absorbs power and simultaneously operating an engine brake, the engine brake being selected from a group consisting of exhaust brakes and compression release brakes and combinations thereof.

In still another form, the present teachings provide a method that includes: providing a hybrid power train having a diesel engine and an electric motor, the diesel engine including a plurality of cylinders, and a fuel injector, a plurality of exhaust valves and a plurality of intake valves being associated with each cylinder; operating the hybrid power train in a first mode wherein the diesel engine is operating; and performing a cylinder cut-out operation when the diesel engine has idled for a time that exceeds a predetermined time increment, the cylinder cut-out operation being configured to de-activate all but a predetermined quantity of cylinders, the predetermined quantity of cylinders being less than or equal to two.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

Additional advantages and features of the present invention will become apparent from the subsequent description and the appended claims, taken in conjunction with the accompanying drawings, wherein:

FIG. 1 is a schematic representation of a conventional hybrid vehicle;

FIG. 2 is a schematic of a hybrid power train constructed in accordance with the teachings of the present invention;

FIG. 3 is a schematic of an alternative hybrid power train constructed in accordance with the teachings of the present invention, the hybrid power train being equipped with clutch between the engine and the motor/regenerative brake;

FIG. 4 is a schematic of a portion of the hybrid power train of FIG. 2 illustrating the internal combustion engine in greater detail;

FIG. 5 is a plot illustrating the catalyst conversion efficiency of the hybrid power train of FIG. 2 with and without auxiliary heating of the catalyst;

FIG. 6 is a plot illustrating the capabilities of the fuel injection system of the internal combustion engine;

FIG. 7 is a plot illustrating the valve lift of a variable valve actuation system associated with the internal combustion engine;

FIG. 8 is a schematic illustration of a portion of the hybrid power train of FIG. 2 illustrating the electronic controller in greater detail;

FIG. 9 is an operating diagram of steady state torque map for a hybrid vehicle employing the hybrid power train of FIG. 2;

FIG. 10 is an operating diagram illustrating the transient operating control of the hybrid power train of FIG. 2 when the motor assisted turbocharger is operated in accordance with the teachings of the present invention;

FIG. 11 is a schematic illustration in flow chart form of a control strategy for a heavy-duty hybrid vehicle performed in accordance with the teachings of the present invention;

FIG. 12A is a schematic illustration in flow chart form illustrating a method for regenerative brake control performed in accordance with the teachings of the present invention; and

FIG. 12B is a schematic illustration in flow chart form illustrating a method for treating exhaust emissions from a hybrid vehicle in accordance with the teachings of the present invention.

### DETAILED DESCRIPTION OF THE VARIOUS EMBODIMENTS

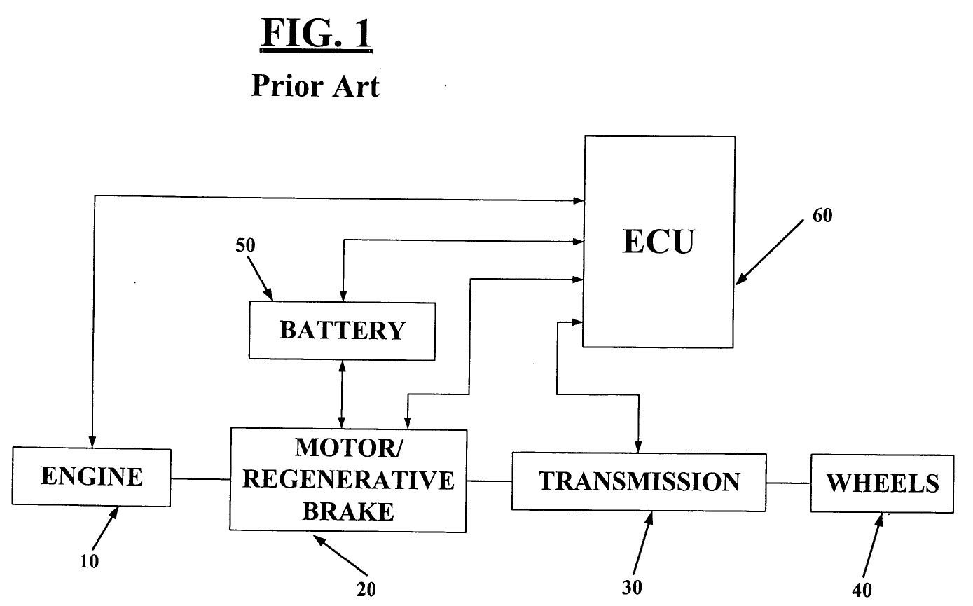

A schematic of a conventional serial hybrid power train is shown in FIG. 1. The numeral 10 designates a turbocharged diesel engine for use in a vehicle drive train. A motor/regenerative brake is shown at 20. Both diesel engine 10 and motor/regenerative brake 20 are connected to a multiple ratio transmission 30. Transmission 30 is mechanically connected to a pair of vehicle driving wheels 40. A battery 50 serves as an energy storage device which is electrically connected to motor/regenerative brake 20. An electronic controller unit 60 is coupled to the engine 10, the motor/regenerative brake 20, the transmission 30 and the battery 50 and controls the overall operation of the drive train.

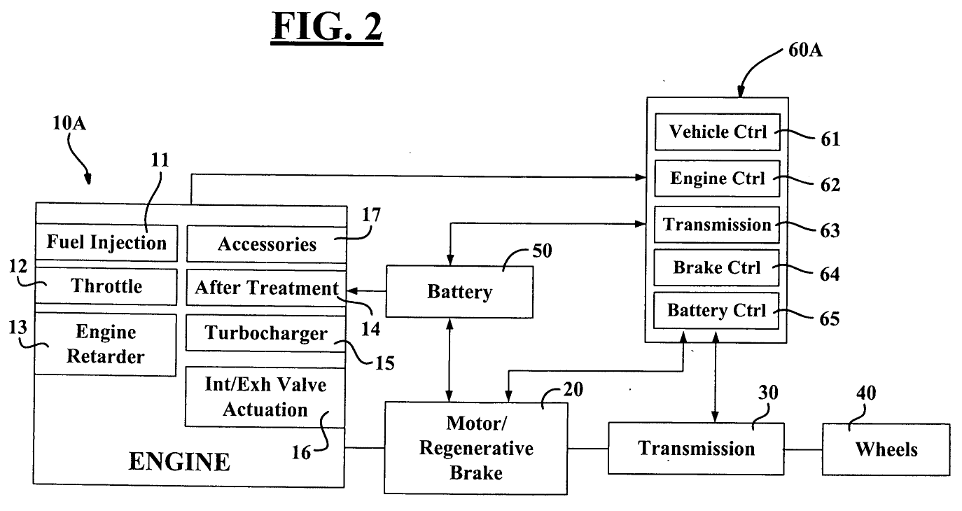

Referring to FIG. 2, a drive train constructed in accordance with the teachings of the present invention is illustrated to include an integrated internal combustion engine 10A. Engine 10A can include various controllable systems including a fuel injection system 11, a throttle system 12, an engine retarding mechanism 13, an aftertreatment system 14, which can include a NOx reduction catalyst and a diesel particulate filter, a turbocharger 15, an intake/exhaust valve actuation system 16 for cylinder cutout and variable valve timing, in addition to power-operated accessories 17. Likewise, the electronic controller or ECU 60A can include several control functions including a vehicle control function 61, an engine control function 62, a transmission control function 63, a motor-generator brake control function 64, and a battery control function 65.

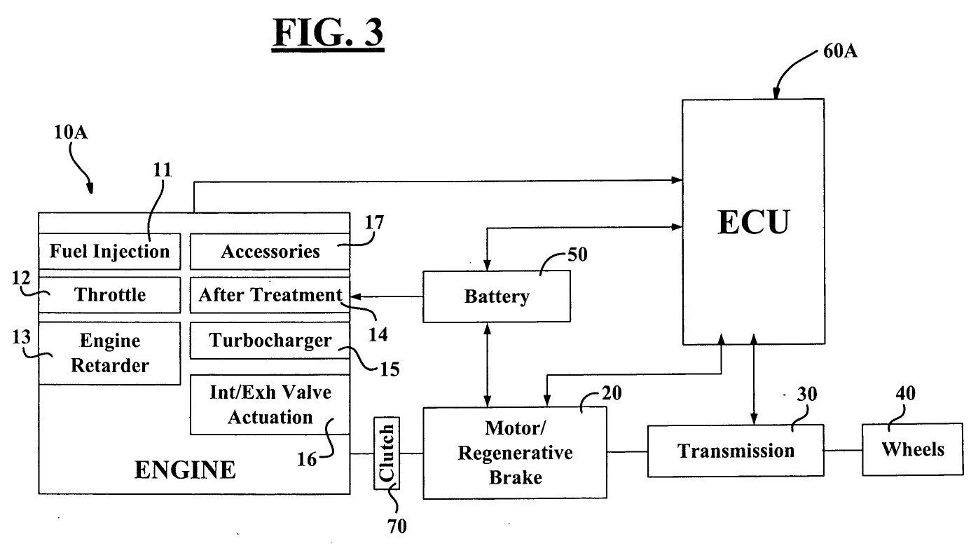

FIG. 3 shows an alternative configuration for the integrated internal combustion engine 10A within the hybrid power train. Specifically, a clutch device 70 is placed in between internal combustion 10A engine and motor 20.

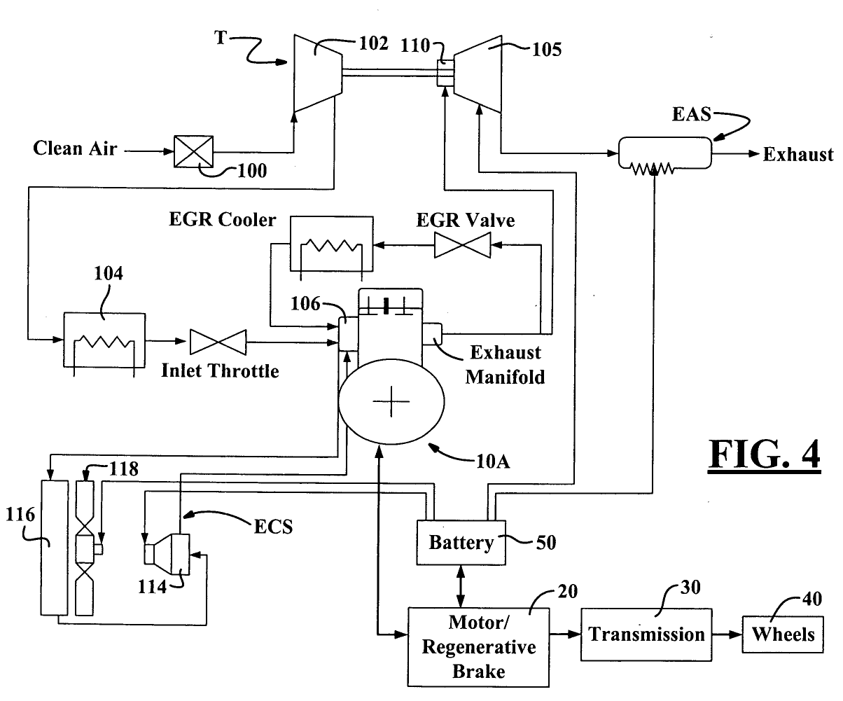

FIG. 4 is a schematic illustration of the hybrid power train illustrating the engine 10A in greater detail. The engine 10A can include an intake manifold 106, an exhaust manifold EM, an exhaust gas recirculation valve EGRV, an exhaust gas recirculation cooler EGRC, a turbocharger T, an exhaust aftertreatment system EAS, a charge air cooler 104, an inlet manifold throttle IMT, and a coolant system CS. Clean air entering an air intake system passes through an air filter 100 and is directed to the compressor 102 of the turbocharger T. Compressor 102, which is driven by the turbine 105 of the turbocharger T, compresses the incoming air to thereby increase its pressure. The pressurized air can be cooled as it passes through a charge air cooler 104 prior to entering the intake manifold 106.

The energy of the exhaust air can be used to drive turbine 105. The turbocharger T can be configured with variable geometric nozzles 108 and/or a high-speed motor 110, which can be powered by the battery 50 of the hybrid power train. The high-speed motor 110 can increase the responsiveness of the turbocharger T at part load operating conditions and during acceleration. The high-speed motor 110 can be a permanent magnet motor/generator, such as a {insert model of motor} motor marketed by {insert manufacturer of motor}. Optionally, the high-speed motor 110 can be employed to generate electric power (when the motor 110 is not being actuated to operate the turbocharger T) to recharge the battery 50. It will be appreciated that exhaust gases from the internal combustion engine 10A can be recirculated (i.e., returned to one or more of the cylinders of the internal combustion engine 10A) to control a speed at which the turbine of the turbocharger T rotates.

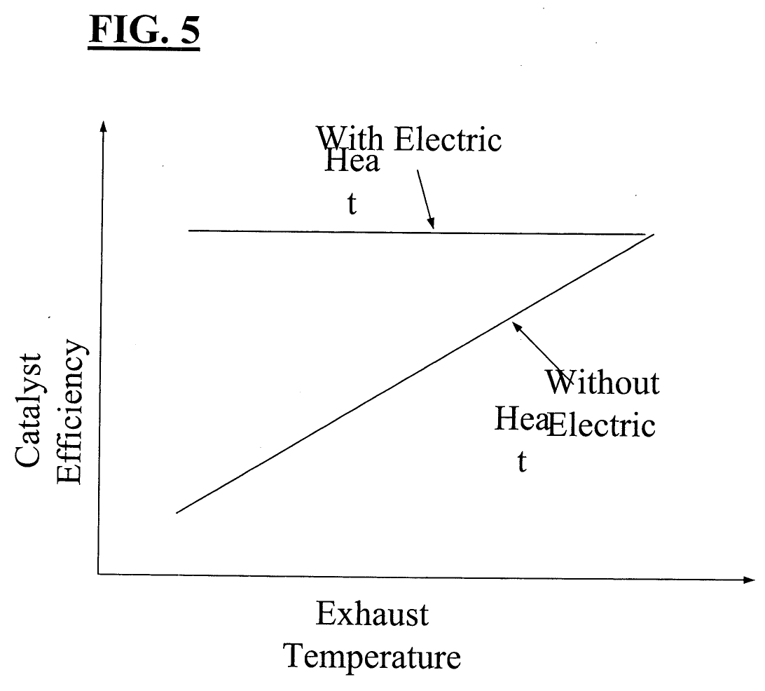

The exhaust aftertreatment system EAS can be employed to reduce the amount or concentration of pollutants in the exhaust gas, such as oxides of nitrogen (NOx) and particulate matter (PM), prior to discharging the exhaust gas to the ambient. The efficiency of the exhaust after treatment system EAS is temperature dependent. At various times the conversion efficiency of the exhaust aftertreatment system can be relatively low due to low exhaust temperature during low speed and/or part load operation and/or start up operation. An electric heater 112 can be used to heat the exhaust after treatment system EAS to a predetermined temperature, such as its optimum conversion temperature, regardless of the engine-operating conditions. Battery 50 of the hybrid power train provides the power to electric heater 112. The conversion efficiency comparison of the exhaust aftertreatment system EAS with and without supplemental heat is shown in FIG. 5.

Returning to FIG. 4, the engine coolant system ECS can employ a water pump 114 to circulate engine coolant to cool the engine 10A. Hot coolant can flow to a radiator 116, which can be cooled by a fan 118. The water pump 114 and cooling fan 118 can employ electric motors, which can be powered by battery 50 of the hybrid power train, instead of being driven by the engine crankshaft.

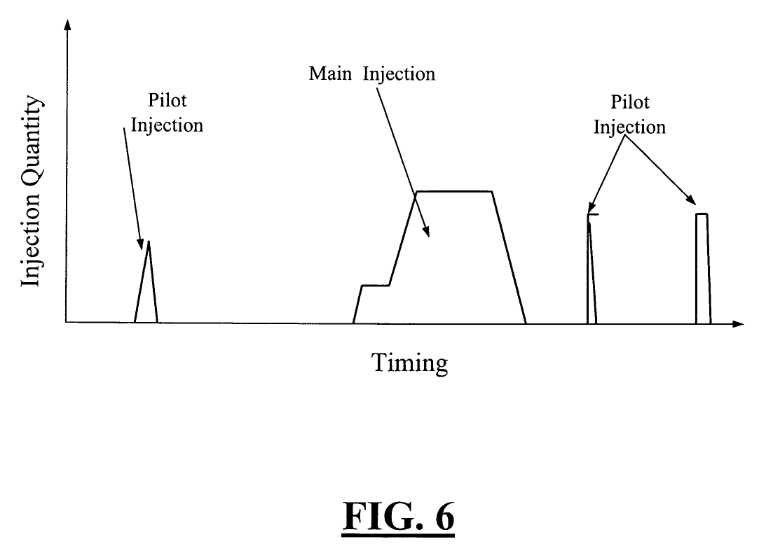

The capability of diesel engine fuel injection system 11 (FIG. 2) is shown in FIG. 6. The fuel injection system 11 (FIG. 2) can include multiple injection and rate shaping capabilities. If employed, a pilot injection event that occurs prior to a main injection event can be employed to reduce combustion noise and NOx emissions. If employed, a first pilot injection event occurring after the main injection event reduces PM emissions with minimum fuel economy penalty, while a second pilot injection event occurring after the main injection and first pilot injection events can provide a source of hydrocarbons that permit the exhaust aftertreatment system EAS (FIG. 4) to reduce NOx emissions.

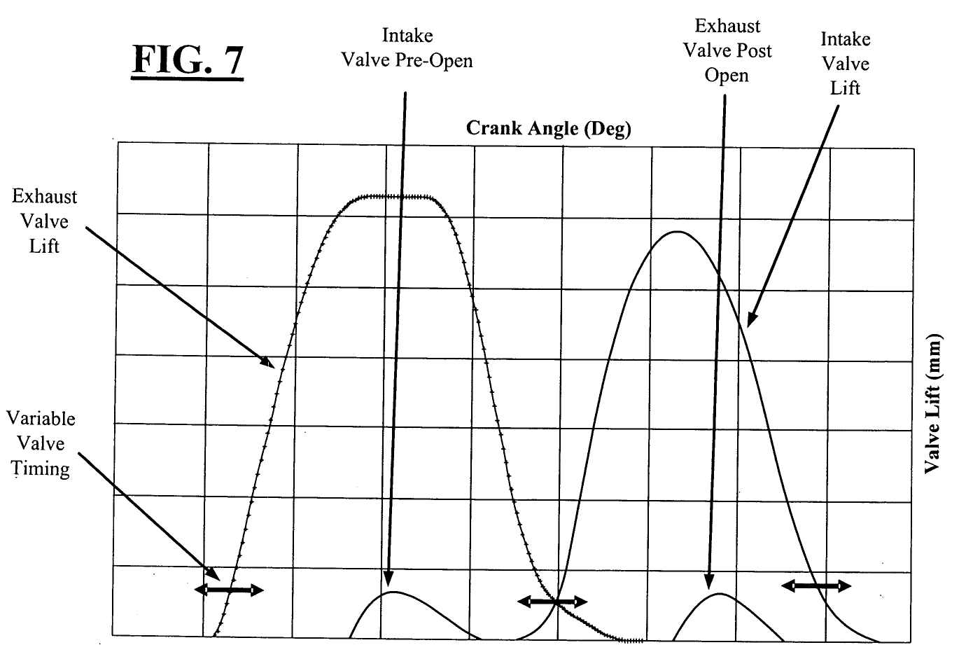

Returning to FIG. 2, actuators (not shown) associated with valve actuation mechanism 16 provide variable timing capabilities. An exemplary valve lift profile is shown in FIG. 7. The valve actuators can be selectively employed to change the timing with which the intake and exhaust valves can be opened and closed, as well as to selectively reopen the valves. Reopening the intake and exhaust valves can reduce pumping losses as when only the motor/regenerative brake is employed to power the hybrid power train. By pre-opening the intake valve during the exhaust stroke, a small portion of the exhaust gas discharges to the intake manifold. This portion of the exhaust gas will be readmitted to the cylinder to mix with fresh air in a manner known as internal exhaust gas recirculation. Generally speaking, exhaust gas recirculation reduces the NOx formation during the combustion process within an engine cylinder. Another exhaust gas recirculation technique is to reopen the exhaust valve during the intake stroke. The exhaust gases will re-enter an engine cylinder from the exhaust manifold to the cylinder due to the relatively high pressure of the exhaust gases in the exhaust manifold.

It will be appreciated that the valve actuation mechanism 16 can be also be employed to vary the compression ratio in one or more of the engine cylinders and/or to vary the displacement associated with one or more of the engine cylinders. Moreover, exhaust gas recirculation may be employed to regulate the speed of the turbine of the turbocharger T so as to control the generation of electricity by the motor that can be employed to rotate the compressor of the turbocharger T.

It will also be appreciated that it will be necessary from time to time to regenerate the exhaust aftertreatment system EAS and as such, it can be desirable to provide both a source of additional hydrocarbons and to elevate the temperature of the exhaust when regenerating one or both of the NOx reduction catalyst and the diesel particulate filter. In the particular example provided, one or more of the fuel injectors can be controlled to perform a post-ignition fuel injection operation wherein fuel is dispensed into an associated cylinder after initiation of a combustion event in the cylinder and prior to completion of an exhaust stroke of a piston in the associated cylinder. Operation of the injector or injectors in this manner eliminates any need for a separate fuel injector and related fuel lines to supply fuel directly to the exhaust aftertreatment system EAS. Moreover, one or more of the exhaust valves may be opened early to increase the temperature of the exhaust gas that is transmitted to the exhaust aftertreatment system EAS.

In combination of the diesel engine's injection capabilities and the valve actuation capabilities, one or more cylinders can be selectively cut out (i.e., not fueled so as to be non-power producing) during part load or the motor only operating modes to maximize the fuel economy. In some situations, such as cruising at a constant speed, the internal combustion engine 10A can be operated in a closed mode wherein one-half of the cylinders of the internal combustion engine 10A (e.g., one bank of a multi-bank engine) are cut-out. In other situations, such as engine idling for a time that exceeds a predetermined amount of time, the internal combustion engine 10A can be operated on one or two of the cylinders while the remaining cylinders are cut-out.

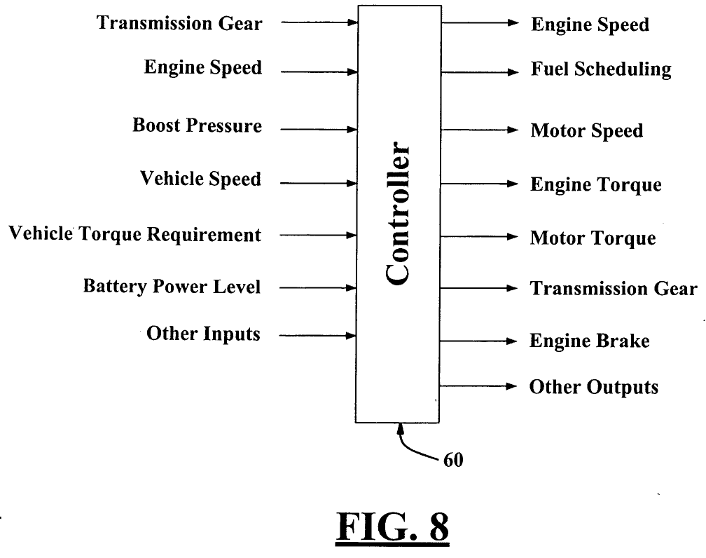

FIG. 8 shows the inputs and outputs of electronic controller 60A. The inputs to the electronic controller 60A (FIG. 2) can include the vehicle torque requirements, vehicle speed, engine speed, engine boost pressure and temperature, battery power level, transmission gear and motor torque level etc. The outputs can include engine speed, torque, engine fueling map, motor torque, transmission gear and retarding power etc.

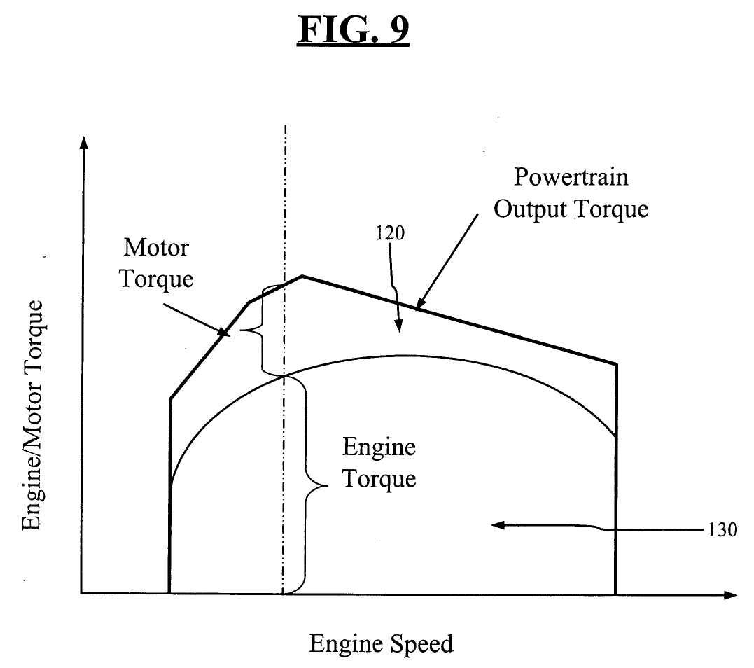

FIG. 9 shows a steady state map of power train (i.e., engine+motor) torque as a function of engine speed. The power train torque comprises the engine torque output 130 from the diesel engine 10A and the motor torque output 120 from electric motor 20.

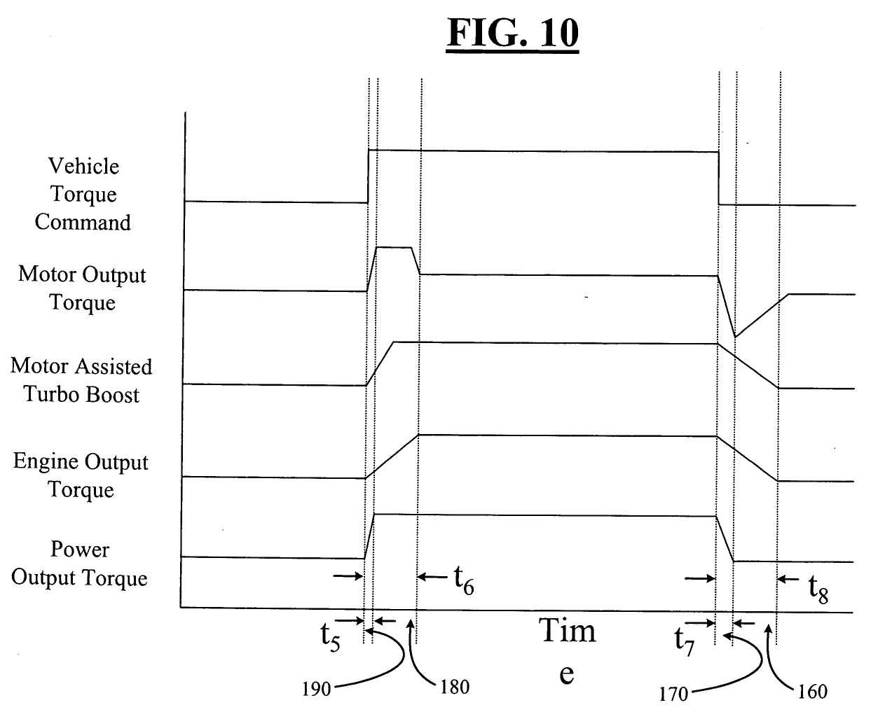

FIG. 10 shows time sequences for the hybrid power train's is transient responses. Plot 150 shows a torque command of a vehicle. The torque command increases torque demand at time t₁ and decreases at time t₅. A plot 160 of the output torque of the motor/regenerative brake 20 (FIG. 2) illustrates that the output torque of the motor/regenerative brake 20 reaches its maximum value at time t₂. A plot 170 of the output torque of the engine 10A (FIG. 2) illustrates that the output torque of the engine 10A reaches a specific value at time t₄. The plot 180 illustrates that the output torque of the hybrid power train (i.e., the combined torque of the motor/regenerative brake 20 and the engine 10A) reaches a specified value at time t₃, which has shorter response time than the engine 10A alone. The plots 150 through 180 also illustrate that the hybrid power train has a relatively fast response when the command torque is decreased.

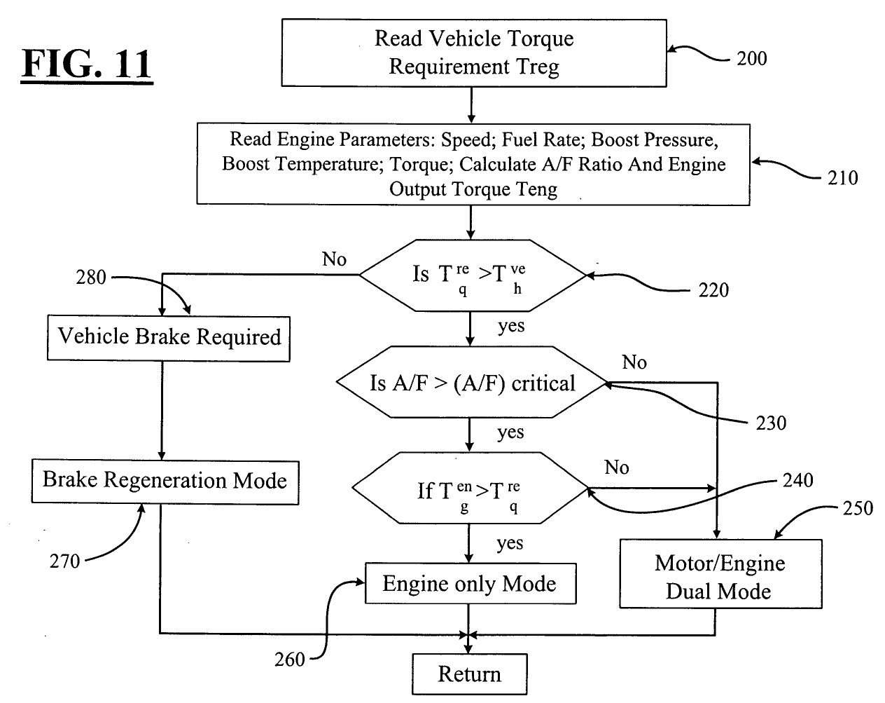

FIG. 11 is a flowchart showing a control strategy for a hybrid power train in accordance with the teachings of the present invention. The methodology begins at block 210 where the ECU 60A (FIG. 2), which receives vehicle data such as vehicle speed, fuel injection rate, boost pressure, temperature, etc. and determines a vehicle torque requirement (Treq) and a vehicle operating torque (Tveh). In block 220, the methodology determines an engine torque output (Teng) of the engine 10A (FIG. 2). In block 230, the methodology compares the vehicle operating torque Tᵥₑₕ and the vehicle torque requirement T_{req}. If T_{req} is not greater than Tᵥₑₕ, the methodology proceeds to block 280 and vehicle braking can be employed, as shown in block 270, to reduce the torque output of the power train such that the vehicle operating torque Tveh is equal to the vehicle command torque Treq. Returning to block 230, if the required torque T_{req} is greater than Tᵥₑₕ, then the methodology proceeds to block 240. In block 240, if the engine torque T_{eng} is not greater than T_{req}, the hybrid power train will operate in a dual engine/motor operating mode as illustrated at block 250. The methodology will then loop back to block 210 as indicated by the block labeled “return”. Returning to block 240, if the engine torque Teng is greater than the vehicle torque command Treq, the methodology will proceed to block 260 and the hybrid power train will operate in an engine only mode.

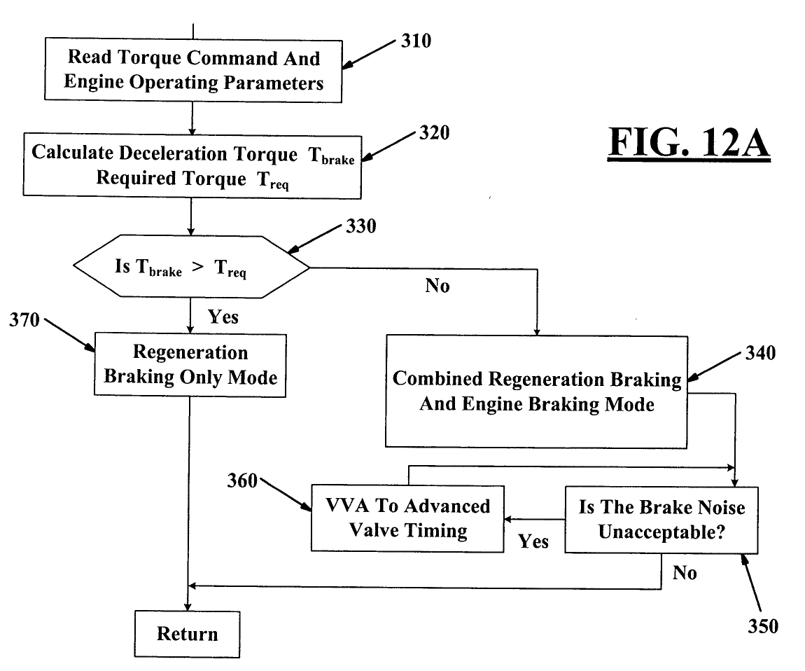

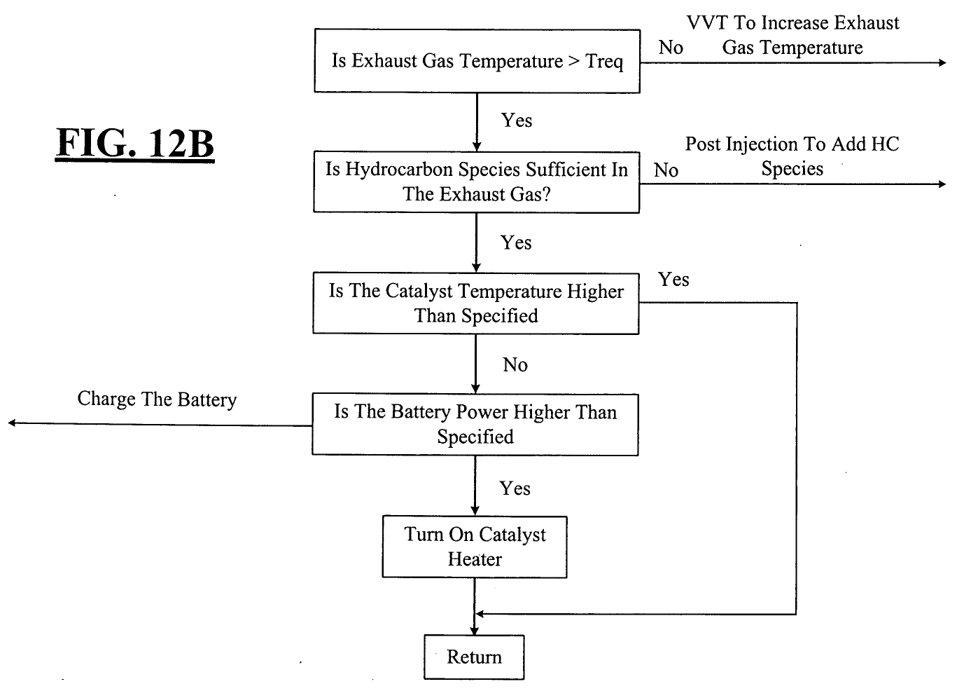

FIG. 12A illustrates a power train regenerating brake control methodology for a hybrid power train in accordance with the teachings of the present invention. The methodology begins at block 310 where the ECU 60A, which receives vehicle data such as vehicle speed, fuel injection rate, boost pressure, temperature, etc., and determines a vehicle torque requirement (Treq). The methodology proceeds to block 320 where a deceleration torque requirement (Tbrake) (which may be based on vehicle speed and other vehicle operating parameters, engine brake torque and/or the motor brake torque) is determined. The methodology determines in block 330 whether the deceleration torque requirement Tbrake is greater than the vehicle torque requirement Treq. If the deceleration torque requirement Tbrake is not greater than the vehicle torque requirement Treq, then engine braking will be activated in combination with the motor regenerating brake, as illustrated at block 340. The methodology will proceed to block 350 to determine whether the amount of noise that is produced by engine braking is relatively higher than desired (e.g., exceeds a level that complies with local noise regulations). If the engine braking noise level exceeds a noise threshold level in block 350, the methodology proceeds to block 360 where the engine valve timing is varied to reduce the noise that is produced by engine braking. The methodology can loop back to block 350. If the engine braking noise level does not exceeds the noise threshold in block 350, the methodology loops back to block 310 as is indicated by the block labeled “return”. Returning to block 330, if the deceleration torque requirement Tbrake is greater than the vehicle torque requirement Treq, the methodology will cause the hybrid power train to operate in a regenerating brake only mode as is illustrated in block 370. The methodology can then loop back to block 310 as is indicated by the block labeled “return”.

FIG. 12B illustrates a methodology in accordance with the teachings of the present invention for controlling an exhaust aftertreatment system (e.g., a catalyst temperature) to improve the effectiveness of the exhaust aftertreatment system in some situations. The methodology begins at block 400 where various vehicle parameters of the engine are determined. In block 430, the methodology compares the exhaust gas temperature with a predetermined temperature threshold, which may be indicative of a temperature required for effective catalyst operation. If the exhaust gas temperature is not greater than the required temperature (Treq), the exhaust valve timing can be adjusted through a variable valve actuation (VVA) device in block 410 to increase the temperature of the exhaust gases. The methodology can loop back to block 430. If the exhaust gas temperature is greater than the required temperature Treq in block 430, the methodology proceeds to block 440 where the methodology determines whether the exhaust gas has an appropriate hydrocarbon concentration. If the hydrocarbon concentration is lower than a predetermined concentration, the methodology proceeds to block 420 where post injection (i.e., a pilot injection event occurring subsequent to a main fuel injection event) or auxiliary exhaust manifold injection is performed to add hydrocarbons into the exhaust gas stream. The methodology can loop back to block 440. If the hydrocarbon concentration is not lower than the predetermined concentration in block 440, the methodology proceeds to block 450 where a temperature of a catalyst in the exhaust aftertreatment system. If the temperature of the catalyst is not higher than a predetermined temperature, the methodology proceeds to block 460 where a battery powered catalyst heater is activated to provide a supplemental amount of heat to increase the temperature of the catalyst as is illustrated in block 460. The methodology can loop back to block 450. If the temperature of the catalyst is higher than the predetermined temperature, the methodology can loop back to block 400 as is indicated by the block labeled “return”.

While the invention has been described in the specification and illustrated in the drawings with reference to various embodiments, it will be understood by those of ordinary skill in the art that various changes may be made and equivalents may be substituted for elements thereof without departing from the scope of the invention as defined in the claims. Furthermore, the mixing and matching of features, elements and/or functions between various embodiments is expressly contemplated herein so that one of ordinary skill in the art would appreciate from this disclosure that features, elements and/or functions of one embodiment may be incorporated into another embodiment as appropriate, unless described otherwise, above. Moreover, many modifications may be made to adapt a particular situation or material to the teachings of the invention without departing from the essential scope thereof. Therefore, it is intended that the invention not be limited to the particular embodiment illustrated by the drawings and described in the specification as the best mode presently contemplated for carrying out this invention, but that the invention will include any embodiments falling within the foregoing description and the appended claims.

What is claimed is:

1. A method comprising:
providing a hybrid power train having a transmission that is selectively powered by a diesel engine, a motor/generator, or both, the diesel engine having a turbocharger, the motor/generator being coupled to a battery which supplies electric power to the motor/generator;
operating the diesel engine;
identifying an event where increased responsiveness of the turbocharger is desired; and
operating an electric motor to drive a compressor in the turbocharger.

2. The method of claim 1, wherein the event where increased responsiveness of the turbocharger is desired includes operating the diesel engine at a partial load, accelerating the diesel engine or both.

3. The method of claim 1, wherein the electric motor is powered by the battery.

4. The method of claim 1, further comprising propelling a turbine in the turbocharger with exhaust from the diesel engine to back-drive the electric motor and generate electricity.

5. The method of claim 4, wherein the diesel engine includes a plurality of exhaust valves and wherein the method further comprises opening at least a portion of the exhaust valves to reduce a quantity of exhaust supplied to the turbine to thereby control a speed at which the turbine rotates.

6. A method comprising:
providing a hybrid power train having a diesel engine and an electric motor, the diesel engine including a NOx reduction catalyst, a plurality of cylinders, and a fuel injector, a plurality of exhaust valves, a plurality of intake valves, and a piston being associated with each cylinder;
operating the hybrid power train in a first mode wherein propulsive power is supplied at least partially by the electric motor;
operating the hybrid power train in a second mode wherein propulsive power is supplied solely by the diesel engine; and
operating at least one of the fuel injectors to perform post-ignition fuel injection wherein fuel is dispensed into an associated one of the cylinders after initiation of a combustion event in the associated one of the cylinders and prior to completion of an exhaust stroke of an associated one of the pistons.

7. The method of claim 6, wherein prior to operating the hybrid power train in the second mode the method further comprises heating the NOx reduction catalyst with an electric heater.

8. The method of claim 7, wherein when the at least one of the fuel injectors is operated to perform post-ignition fuel injection, the method further comprises:
determining a temperature of the NOx reduction catalyst; and
if the temperature of the NOx reduction catalyst is below a predetermined temperature, advancing a time at which the exhaust valves of one or more of the exhaust valves is opened.

9. The method of claim 6, wherein the fuel dispensed into the associated cylinder during post-ignition fuel injection is dispensed in at least two discrete events.

10. The method of claim 6, further comprising:
monitoring a temperature that is associated with an exhaust system of the diesel engine, wherein post-ignition fuel injection is performed when the temperature is less than a first predetermined temperature.

11. A method comprising:
providing a hybrid power train having a diesel engine and a motor/generator, the diesel engine including a NOx reduction catalyst, a diesel particulate filter, a plurality of cylinders, and a fuel injector, a piston, a plurality of intake valves and a plurality of exhaust valves being associated with each of the cylinders;
operating the hybrid power train in a first mode wherein propulsive power is supplied at least partially by the motor/generator;
operating the hybrid power train in a second mode wherein propulsive power is supplied solely by the diesel engine; and
performing a maintenance routine when the diesel engine is operating wherein post-injection fuel is provided to at least one of the cylinders to provide a source of hydrocarbons and valve timing is adjusted to open the exhaust valves of one or more of the cylinders earlier to elevate a temperature of an exhaust of the diesel engine, the maintenance routine being operable to regenerate one or both of the NOx reduction catalyst and the diesel particulate filter.

12. The method of claim 11, further comprising operating at least a portion of the intake valves, at least a portion of the exhaust valves or at least a portion of the intake valves and the exhaust valves to recirculate exhaust within the diesel engine to control a temperature of the exhaust.

13. The method of claim 12, wherein the at least a portion of the intake valves are opened when exhaust is being driven out of an associated one of the cylinders.

14. The method of claim 12, wherein the at least a portion of the exhaust valves are opened when fresh air is being drawn into an associated one of the cylinders.

15. A method for operating a hybrid power train having a transmission, a diesel engine, a motor/regenerative brake, a battery, and an electronic controller, the transmission being selectively powered by at least one of the diesel engine and the motor/regenerative brake, the battery being coupled to the motor/regenerative brake, the electronic controller being coupled to the diesel engine, the motor/regenerative brake and the battery, the diesel engine including a plurality of cylinders, each of the cylinders having one or more intake valves and one or more exhaust valves, the method comprising:
operating the hybrid power train in a mode wherein the diesel engine is not providing rotary power to the transmission;
operating the motor/regenerative brake in a mode that absorbs power to thereby decelerate the hybrid power train and back drive the diesel engine; and
adjusting the valve opening of at least one of the exhaust valves and the intake valves during operation of the motor/regenerative brake in the power absorbing mode.

16. The method of claim 15, wherein adjusting the valve opening is performed in response to a determination that noise emanating from the diesel engine during operation of the motor/regenerative brake in the power absorbing mode exceeds a predetermined threshold.

17. The method of claim 15, wherein adjusting the valve opening includes changing a time at which the valve opening of the at least one of the exhaust valves and the intake valves is opened.

18. The method of claim 15, wherein adjusting the valve opening includes changing an amount by which the valve opening of the at least one of the exhaust valves and the intake valves is opened.

19. The method of claim 18, wherein adjusting the valve opening further includes changing a time at which the valve opening of the at least one of the exhaust valves and the intake valves is opened.

20. A method for operating a hybrid power train having a transmission, a diesel engine, a motor/regenerative brake, a battery, and an electronic controller, the transmission being selectively powered by at least one of the diesel engine and the motor/regenerative brake, the battery being coupled to the motor/regenerative brake, the electronic controller being coupled to the diesel engine, the motor/regenerative brake and the battery, the diesel engine including a plurality of cylinders, each of the cylinders having one or more intake valves and one or more exhaust valves, the method comprising:
identifying a deceleration event in which the hybrid power train is to be decelerated; and
operating the motor/regenerative brake in a mode that absorbs power and simultaneously operating an engine brake, the engine brake being selected from a group consisting of exhaust brakes and compression release brakes and combinations thereof.

21. A method comprising:
providing a hybrid power train having a diesel engine and an electric motor, the diesel engine including a plurality of cylinders, and a fuel injector, a plurality of exhaust valves and a plurality of intake valves being associated with each cylinder;
operating the hybrid power train in a first mode wherein the diesel engine is operating; and
performing a cylinder cut-out operation when the diesel engine has idled for a time that exceeds a predetermined time increment, the cylinder cut-out operation being configured to de-activate all but a predetermined quantity of cylinders, the predetermined quantity of cylinders being less than or equal to two.

22. The method of claim 21, wherein the predetermined quantity of cylinders is equal to one.

23. The method of claim 21, wherein the cylinder cut-out operation includes dispensing no fuel from the fuel injectors that are associated with each of the de-activated cylinders.

24. The method of claim 23, wherein the cylinder cut-out operation includes opening the intake valves, the exhaust valves or both of the de-activated cylinders to reduce pumping losses associated with the de-activated cylinders.
